(19) United States
(12) Patent Application Publication
(10) Pub. No.: US 2011/0307518 A1
(43) Pub. Date: Dec. 15, 2011

(54) Medical Record Management Using Fingerprint ID

(76) Inventors: Vinton John Lewis, Oakdale, MN (US); Cheryl Ann Haydock, Edina, MN (US); Octavio Aguiles Defillo Herandez, Johannesburg (ZA)

(21) Appl. No.: 12/797,647

(22) Filed: Jun. 10, 2010

(51) Int. Cl. G06F 17/30

(52) U.S. Cl. 707/783; 707/E17.001

(57) ABSTRACT

Methods and systems for medical record management using fingerprint identification. Fingerprints of patients, medical professionals, health payer or pharmacy personnel and potential customers are submitted to a central server and are compared with stored fingerprints of registered users. If a match is found, the user is granted an access level of authority based on the stored personal information and a “need-to-know” basis in the medical field.

### DESCRIPTION OF RELATED ART

The present application relates to medical record database management, and more particularly to secure medical record input and access using a fingerprint identification system.

Note that the points discussed below may reflect the hindsight gained from the disclosed inventions, and are not necessarily admitted to be prior art.

Medical records have traditionally been maintained in a paper format. As electronic medical records are more widely implemented, a secure integration of systems is essential.

Systems have been developed which electronically manage medical documents or billing, such as described in U.S. Pat. Nos. 5,991,730, 5,991,729, 5,946,659, 5,933,809, and 5,899,998 to Lubin et al., Barry et al., Lancelot et al., Hunt et al. and McGauley et al., respectively.

However, only fewer than about 5% of all physicians utilize some sort of electronic medical record (EMR) system. Service professionals have resisted those systems since they are unable to keep up with the rapid pace and movement of the service professional during the various tasks which are performed throughout the day.

U.S. Pat. No. 7,716,072 B1 discloses an integrated electronic system to ease the anxiety involved in using technology where patient's medical history, assessments, interventions, progress notes, medication lists, consultation dictation, laboratory values, radiology reports are stored in a central server system; and service professionals including health care providers such as physicians, nurses, pharmacists, dental health professionals and other medical clinicians can register and login to this system using usernames and passwords.

U.S. Pat. No. 7,716,072 B1 is incorporated by reference to provide further background information.

However, medical or confidential records have long had a history of being breached, hacked or mishandled by people with the intent to defraud or by non-authorized personnel. Fraud or breach of patient's confidential medical records are on an alarming rise. Most security systems utilize username/password logins, where users often have to memorize multiple passwords for different systems. For security reasons, systems often prompt for changing the passwords after a period of time. This creates confusion and loss of passwords. In emergent situations, recalling a password may result in a delay of critical intervention for a patient.

Fingerprint identification systems, as a more secure system, have been integrated into electronic monetary transaction system, for example, as disclosed in U.S. Pat. No. 6,523,745 B1. IDs with fingerprints do not require generating certain fixed ID codes every time the system is to be accessed. It is quite impossible to steal a fingerprint ID.

### SUMMARY

The present application discloses software plus a central server medical record system called MediFingerprintID™. The system incorporates ProLevel™ proprietary software along with M.E.D.I©, the Medical Enhanced Database Information, that uses a fingerprint identification system to identify users.

In one embodiment, a medical system user's fingerprint is utilized to access an electronic medical record. The fingerprint is collected electronically, transmitted to a medical record database to access a particular patient's medical record where the collected fingerprint is compared to a previously registered fingerprint, and granted access to the medical record at the assigned ProLevel™.

In one aspect of an embodiment, a patient, or a medical professional, or a medical payer personnel has their respective electronic fingerprint sensor IC card which collects and transmits the card holder's fingerprint and also transmits whether the card holder is a patient, a medical professional, or a medical payer personnel.

In one embodiment, the MediFingerprintID™ system has an access restriction rule based on currently accepted method of “need-to-know” basis in the medical field. Medical record accesses are classified into at least six levels based on a medical professional's responsibility and field of medical practice.

Patient's fingerprint access to medical records provides an improved and more reliable method in the pre-hospital environment of giving emergency personnel rapid, reliable, unique form of wireless identification in emergencies and extreme situations, or when the patient is not able to communicate because of a rapid deterioration of his/her condition and level of consciousness, a situation not uncommon in medical emergencies, trauma, elderly, and disabled patients.

In the in-hospital environment, the MediFingerprintID™ system upgrades the most needed current barcode, username and password systems, which is outdated, very weak, and at risk of fraudulent transaction by outside hackers or institution's staff. Fingerprint identification upgrades such systems by “beefing up”, improving, and implementing maximum security of patient's medical, individual personal and confidential records retrieved in levels of “need to know” status by grading level of accessibility according to medical and hospital personnel needs.

In the non-emergent, in-hospital or consultation situation, a patient in conjunction with approved medical staff, has the right to view their medical records. The MediFingerprintID™ system improves hospital management by providing a rapid admission process, reducing administrative cost, limiting the handling and passing of confidential information such as social security number, medical insurance information, other personal and medical information which are needed, and in many cases, unintentionally divulged in front of non related persons. These are the most common forms of breach of confidentiality in the healthcare environment.

The MediFingerprintID™ system also provides the hospital authorities with accurate information of whom and when a breach of confidentiality or improper handling of patient's medical information took place inside the hospital, clinic and consulting rooms. Fingerprint identification is unique to all humans; it is reliable, accurate, provides patients with the peace of mind that their information is well protected, guarded, and rapidly available when needed.

In one embodiment the MediFingerprintID™ system allows pharmacists in a retail setting to check the background of specific individuals purchasing drugs. By scanning the fingerprint into the system, potential substance abusers will be identified and the pharmacy can reserve the right to not sell drugs to that individual.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 schematically shows an example structure and function flow chart of the components of an MediFingerprintID™ system in accordance with this application.

FIG. 2 shows an example of function flow chart of a fingerprint matcher component in accordance with this application.

FIG. 3 shows an example of function flow chart of the authorization component in accordance with this application.

FIG. 4 shows an example of “need-to-know” based authorization hierarchy in accordance with this application.

FIG. 5 shows an example function flow chart of a registration component in accordance with this application.

FIG. 6 shows an example of the MediFingerprintID™ system in transmission of information in accordance with this application.

FIG. 7 shows an example IC card for fingerprint input in accordance with this application.

FIG. 8 shows an example function flow chart in accessing the

MediFingerprintID™ system in accordance with this application.

FIGS. 9A, 9B, 9C, 9D, 9E show example user interfaces in accessing the MediFingerprintID™ system in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The present invention will be described with reference to the drawings.

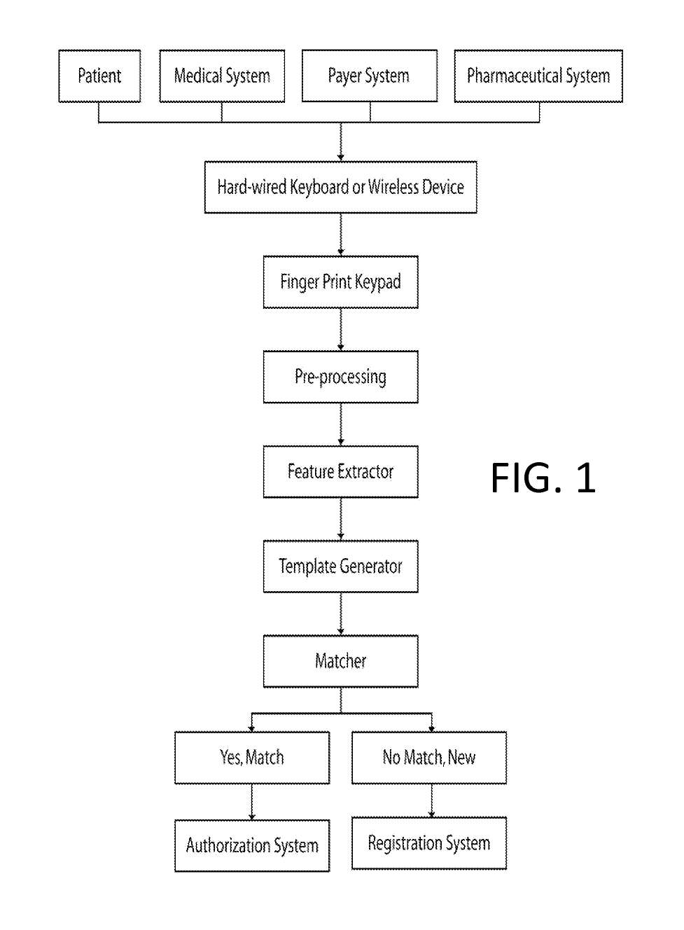

In reference to FIG. 1, each patient or person maintaining any type of personal or confidential medical records with a private or public professional institution, including government healthcare institutions, under this invention would be requested or required, depending on the institution, to have their fingerprint registered. This is accomplished by means of a fingerprint reader, software to operate that reader and a user friendly system that incorporates software and hardware to integrate with the database containing the confidential medical records. Once the fingerprint from the patient or person maintaining any type of confidential medical records is on file, it becomes highly unlikely that the record would succumb to breach, hacking or left unattended.

A person who is accessing the medical record information database may need to identify whether he/she is a patient, a medical professional or other personnel, such as a payer, pharmacy representative or potential customer. Each time a patient or person visiting a professional healthcare institution presents his or herself for admission, they would be requested or required to enter their fingerprint by means of a fingerprint reader. The fingerprint reader (key pad) delivers the fingerprint through a fingerprint ID scanner to a pre-processing module and Feature extractor which extracts the fingerprint features and sends it to a Template generator which then generates a fingerprint template or binary image which is then sent to the central server of the M.E.D.I. database.

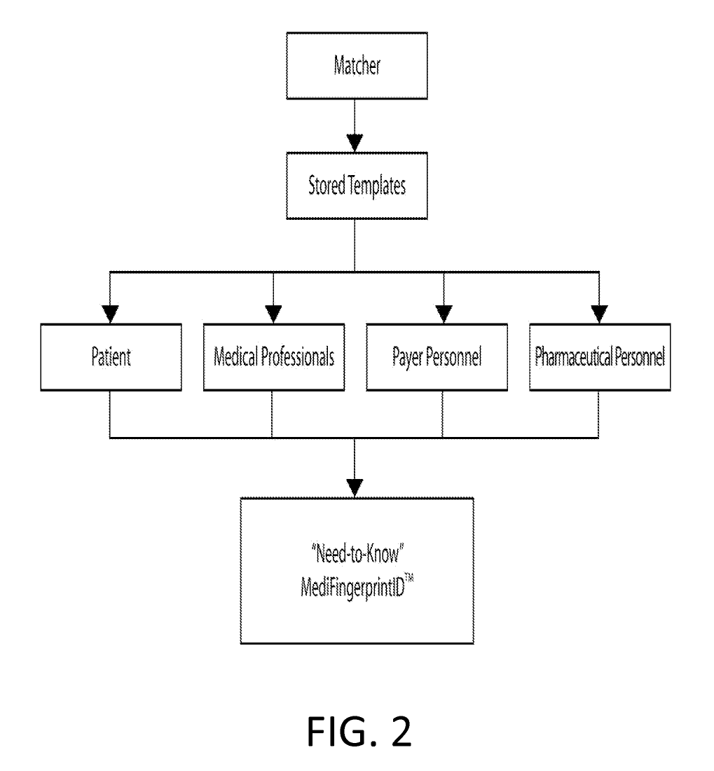

The Matcher module, as shown in FIG. 2, on the central server then compares the received fingerprint template with the stored fingerprints in the database, if there is a match, the process goes further to the Authorization module; if the received fingerprint does not match any of the stored fingerprints, the process goes to the Registration module.

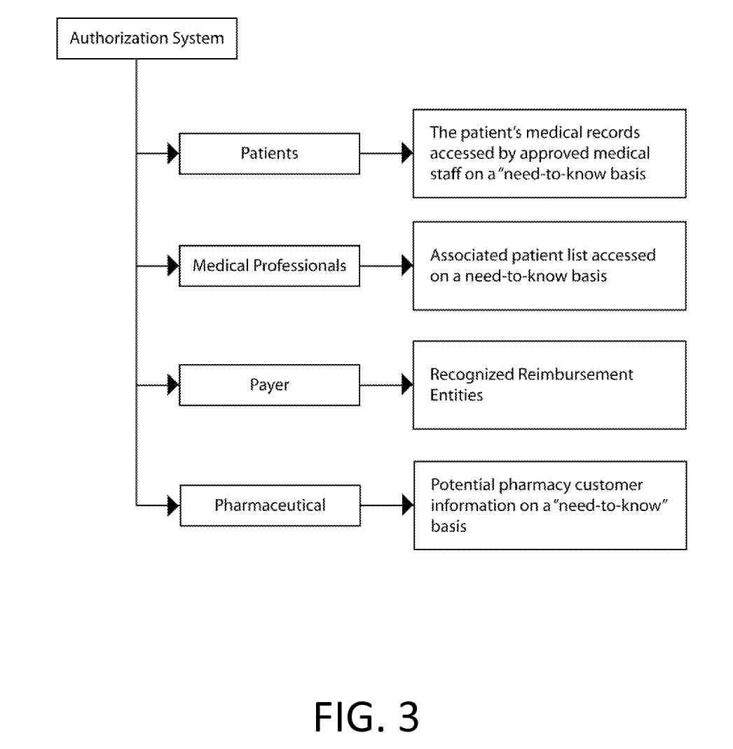

In reference to FIG. 3, the authorization system then makes available the allowed level of record access. If a patient requests to view their medical records, approved medical staff based on their ProLevel™ “need to know” status, may access the medical record and share same with the patient. If the accessing person is a medical professional, the database accessing authority is then granted a “need-to-know” hierarchy set up by the maintaining institution or the medical professional associated institution. A list of patients under the accessing medical professional is then retrieved and displayed. The patients' medical or individual's confidential records are made available for viewing. If the accessing person is a payer personnel, the associated reimbursement entities may be listed and displayed. Authority to access the confidential records may be determined and authorized by each of the reimbursement entities. If the accessing person is a potential customer at a pharmacy, the pharmacy personnel will receive customer information on a “need to know” basis concerning potential drug abuse.

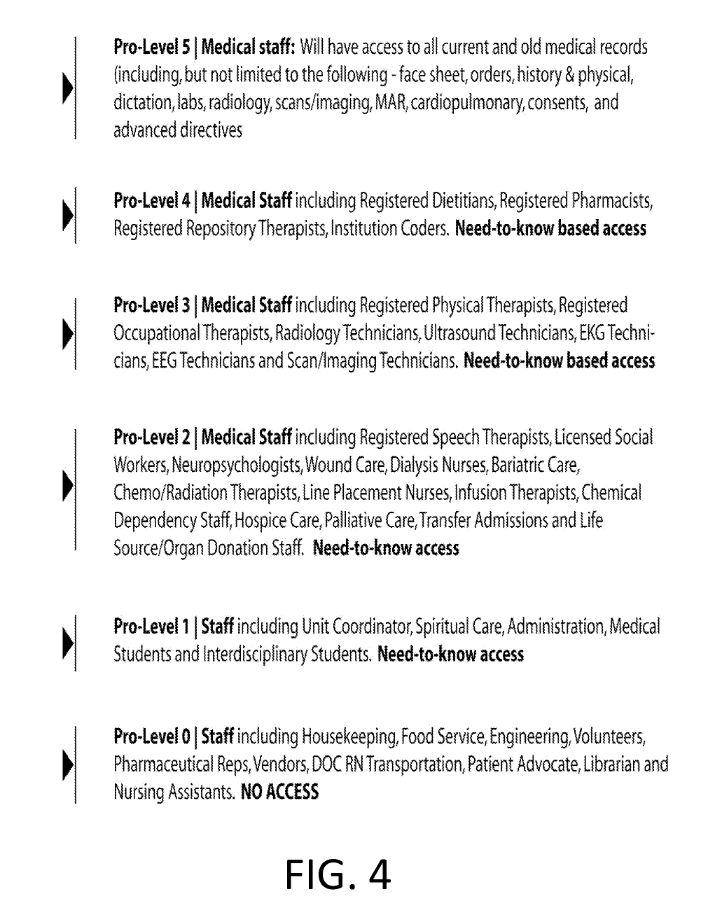

In reference to FIG. 4, it shows an example of six levels of accessibility of the patient or individuals records based on the industry proven method of “need to know” basis. This clearly allows for greatly improved security of confidential medical records.

Multiple staff in a hospital would need to interact with a patient confidential medical records at specific levels of “need to know” basis. In present application, the authorization module in the MediFingerprintID™ system separates levels of staff and the “need to know” medical information concerning the patient. Each hospital can also customize each hospital staff level of “need to know” basis requirements.

For example, for an inpatient, the highest level, Pro-Level 5, allows for complete record access. This level of access may be granted to all primary attending Physicians, Partners, Physician Assistants, and Nurse Practitioners within a recognized accredited practice who are registered into the MediFingerprintID™ system by scanning his/her fingerprint. The database will list all current in-patients treated by a particular physician group.

Unlike the conventional password access system which opens the medical records of any patient regardless of whether or not the staff member is consulting on the particular patient, the medical professional will only have access to the patients registered to his/her practice. Pro-Level™ 5 allows full access to all current and old medical records, including, face sheet, orders, history & physical, dictation, labs, radiology, scans/imaging, MAR, cardiopulmonary, consents, advanced directives, etc.

Pro-Level™ 4 may be granted to Registered Dietitians, Registered Pharmacists, Registered Respiratory Therapists, Institution Coders in Finance Department who are registered into the MediFingerprintID™ system by scanning his/her fingerprint. This level allows partial access to sections of the medical records, specific to “need to know” basis.

Pro-Level™ 3 may be granted to Registered Physical Therapists, Registered Occupational Therapists, Radiology Technicians, Ultra sound Technicians, EKG Technicians, EEG Technicians and Scan/Imaging Technicians who are registered into the MediFingerprintID™ system by scanning his/her fingerprint. This level allows limited access to sections of the medical records specific to “need to know” basis.

Pro-Level™ 2 may be granted to Registered Speech Therapists, Licensed Social Workers, Neuropsychologists, Wound Care, Dialysis

Nurses, Bariatric Care, Chemo/Radiation Therapists, Line Placement Nurses, Infusion Therapists, Chemical Dependency Staff, Hospice Care, Palliative Care, Transfer Facility Admissions and Life Source/Organ Donation Staff, who are registered into the MediFingerprintID™ system by scanning his/her fingerprint. This level allows limited access to sections of the medical records specific to “need to know” basis.

Pro-Level™ 1 may be granted to Unit Coordinators, Spiritual Care, Administration, Medical Students and interdisciplinary students who are registered into the MediFingerprintID™ system by scanning his/her fingerprint. This level allows limited access to sections of the medical record specific to “need to know” basis.

Pro-Level™ 0 may be granted to Housekeeping, Food Service, Engineering, Volunteers, Pharmaceutical Reps, Vendors, DOC RN Transportation, Patient Advocate, Librarian and Nursing Assistants who are registered into the MediFingerprintID™ system by scanning his/her fingerprint. These personnel will have no access to sections of the medical records specific to “need to know” basis. If the above staff makes a real attempt to access medical records the MediFingerprintID™ system will automatically block the access and notify the IT department.

Further, patient billings are submitted to the billing department and processed by billing staff who have been authorized by MediFingerprintID™ fingerprint technology and stored in the institutions secure M.E.D.I database.

Each of these levels is accessed by means of the persons fingerprint. If a non-authorized individual tries to access patient or individual confidential information by entering his/her own fingerprint, the system immediately alerts security of the mistaken entry or potential breach. If an authorized individual fails to return a patient's medical records to the secure M.E.D.I. database, the system automatically does so and then alerts security of the misuse or breach. A daily report is made available to security outlining potential breach or misuse of the system.

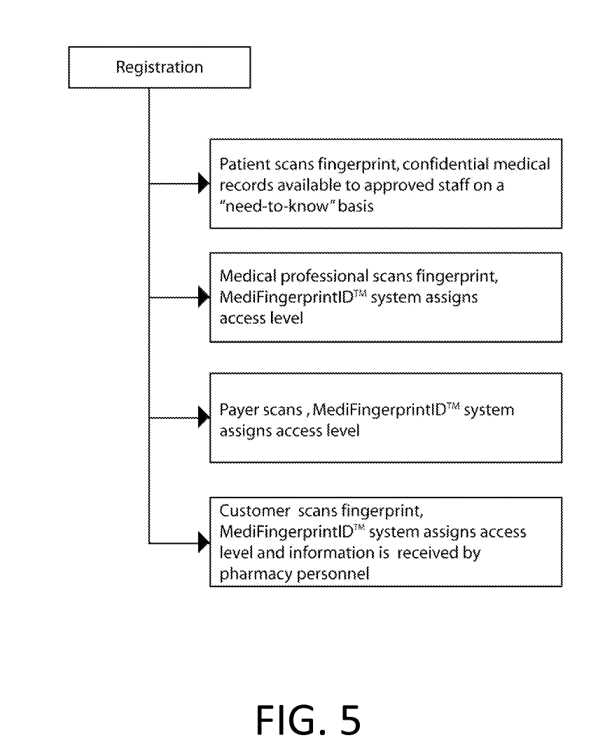

In reference to FIG. 5, when no fingerprint match is found in the M.E.D.I. database, the user is brought to the registration module for new user registration. For new patients, a fingerprint is requested along with personal information, which is then submitted and stored in the database. For medical personnel and other users, information accessing ProLevel™ is assigned and fingerprint and other medical practice related information may be stored. The institution may customize the accessing authority for a particular individual.

All new hires and existing staff of an institution may be requested or required to fill out a simple computer form and enter their fingerprint with the form. This information will be stored and the IT department or security division of the institution will assign the ProLevel™ at which the individual is authorized to access. Individuals may be notified of their assigned levels within the MediFingerprintID™ system and simple instructions on how to use the system.

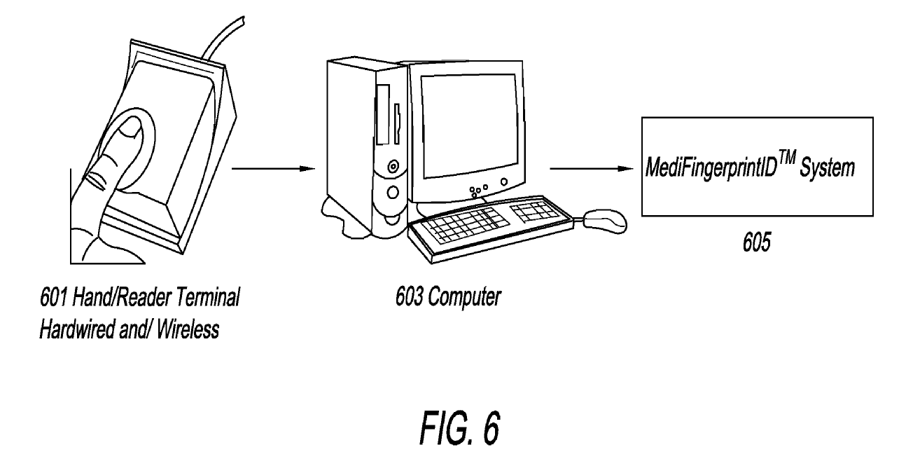

FIG. 6 demonstrates a fingerprint ID accessing system, where the accessing person scans his/her finger on a fingerprint reader/hand terminal 601, either hard wired or wireless, which may be stored or inspected on a computer 603. Then a processed fingerprint is transmitted to the M.E.D.I central medical record server 605 for matching or registration process.

The current commercially available waterproof fingerprint identification hardware such as the Zvetco™ P4500 may be incorporated into the medical record management system. This fingerprint hardware device could be hard wired to a laptop/desktop computer. For wireless use, a device such as the BlueCheck™ manufactured by Cogent Systems could be used to access the medical record management system.

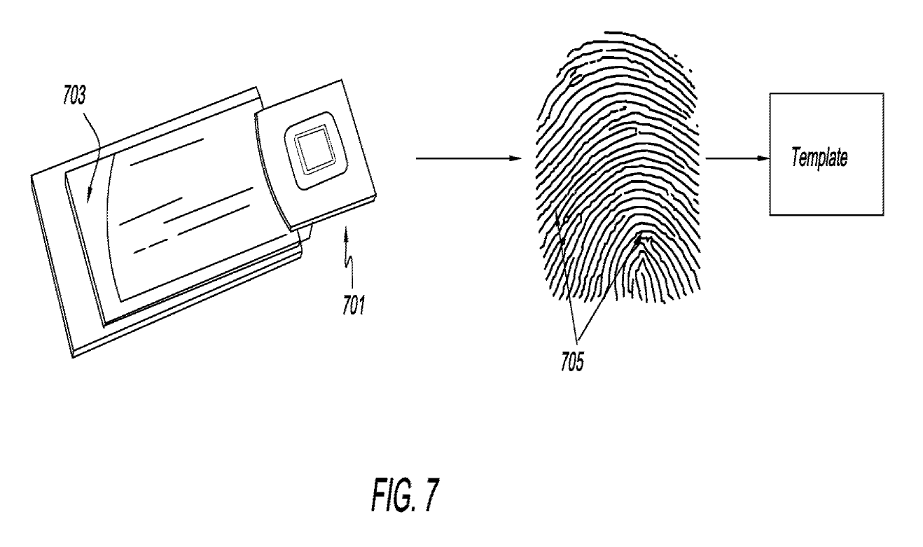

Registered patients or medical professionals or other users may be provided with a fingerprint IC card as shown in FIG. 7, and described in

U.S. Pat. No. 6,523,745 B1, the entirety of which is therefore incorporated by reference. The IC card includes a fingerprint sensor 701 which can include an identification number (or employee number, medical insurance number), an image processing module and a data transmission module 703 that can communicate with a computer wirelessly. Generated binary fingerprint image is characterized with a set of fingerprint points 705 called minutiae. Sets of fingerprint points 705 are transmitted to M.E.D.I server to compare with stored fingerprint data.

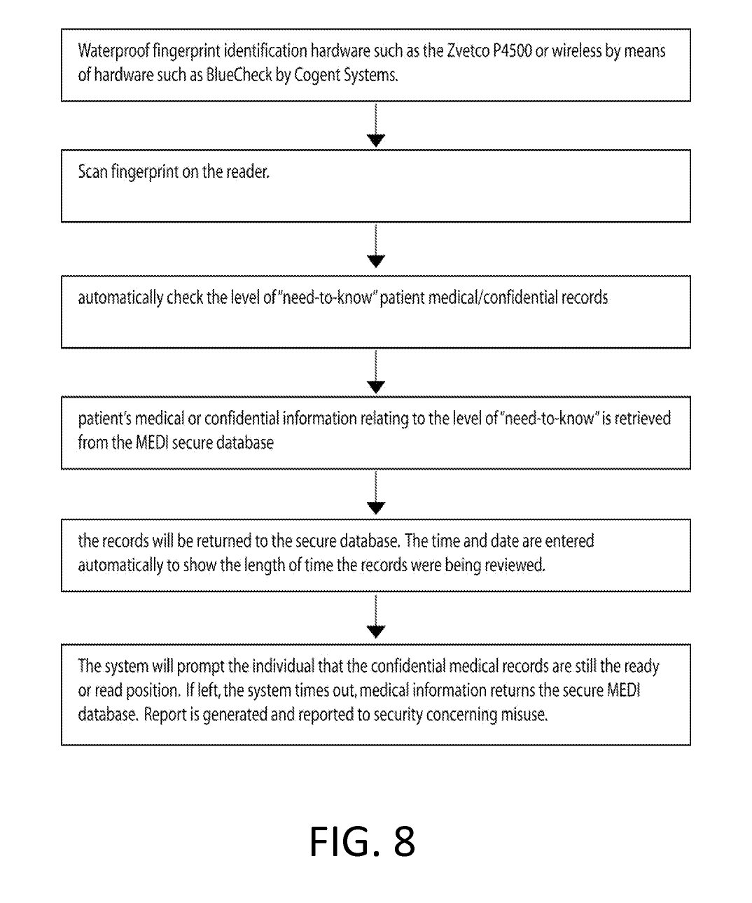

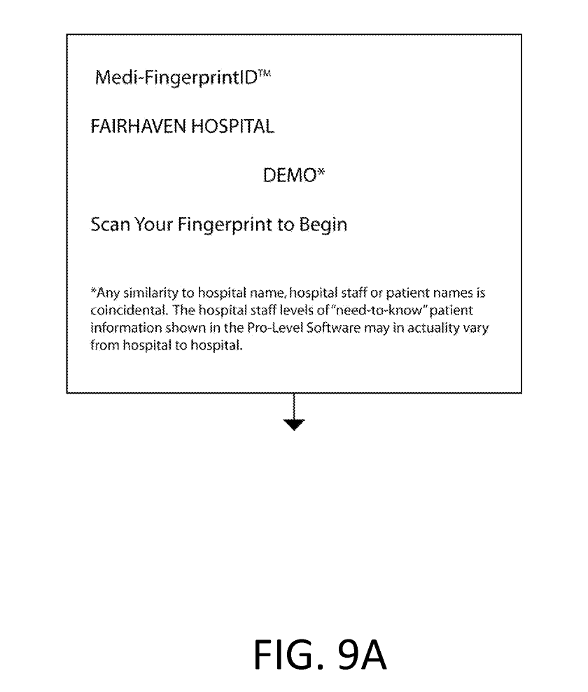

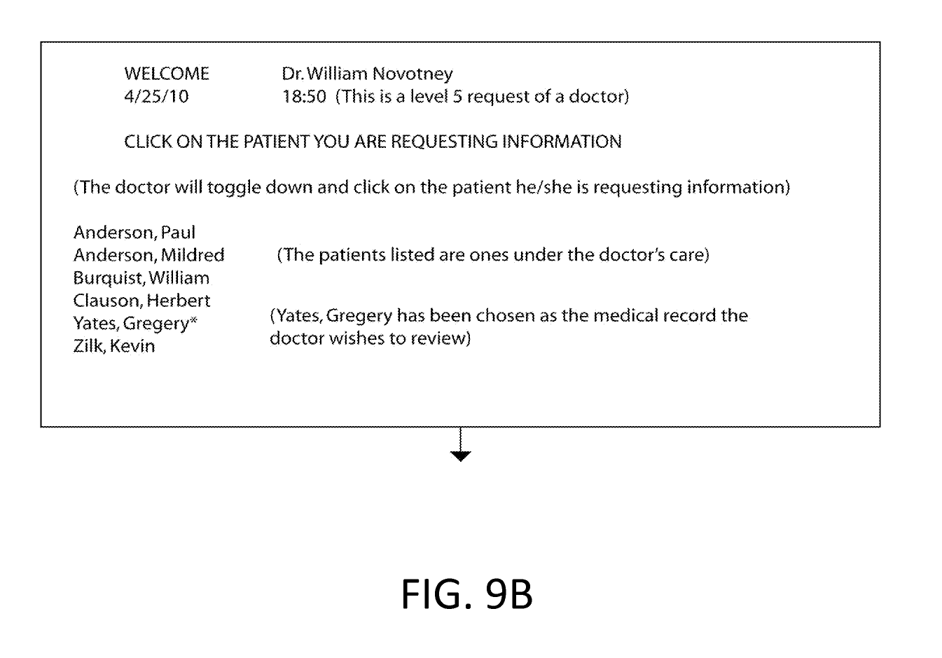

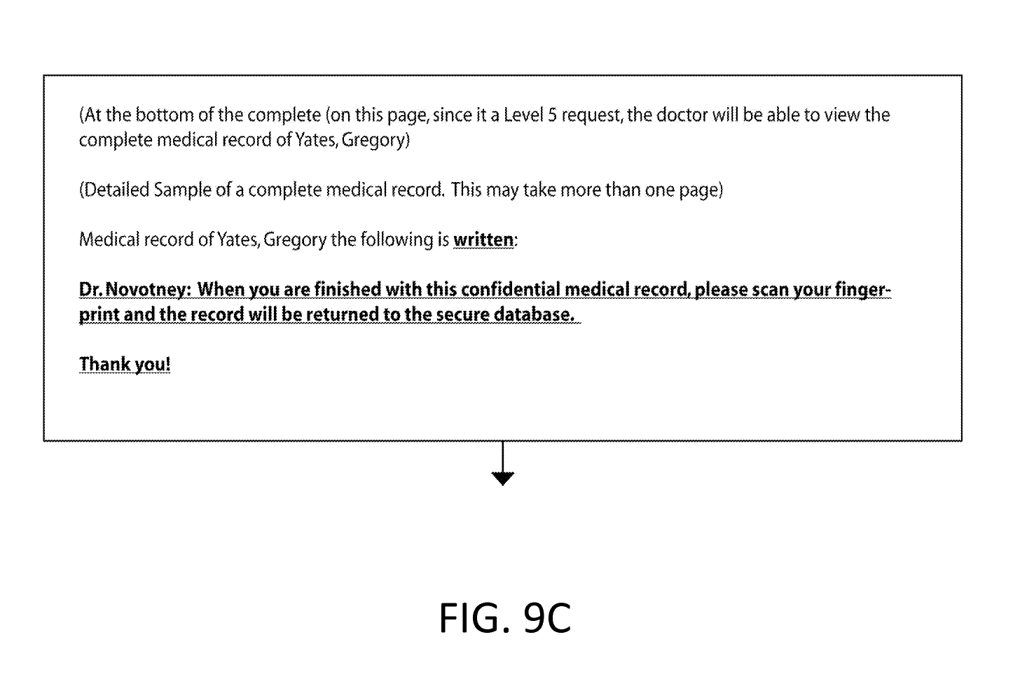

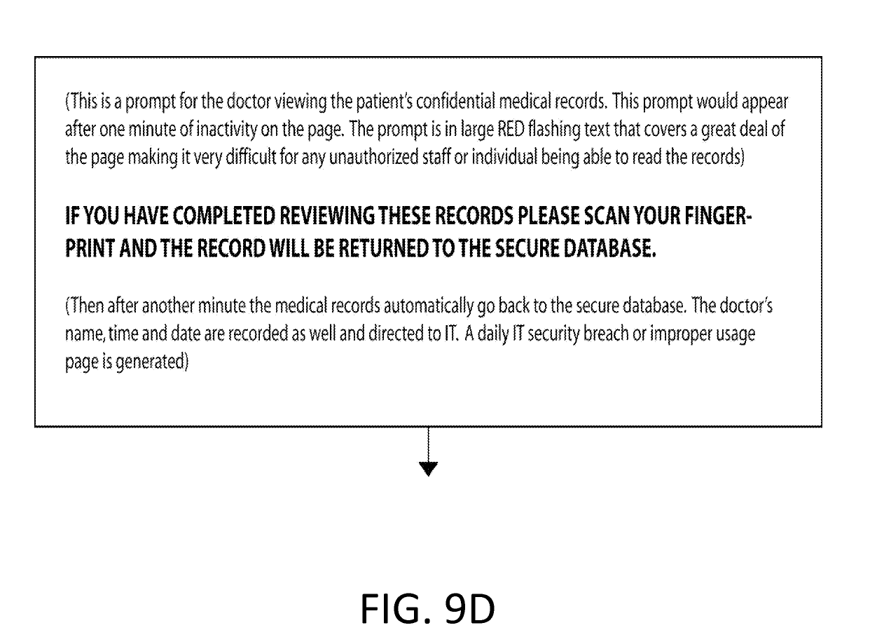

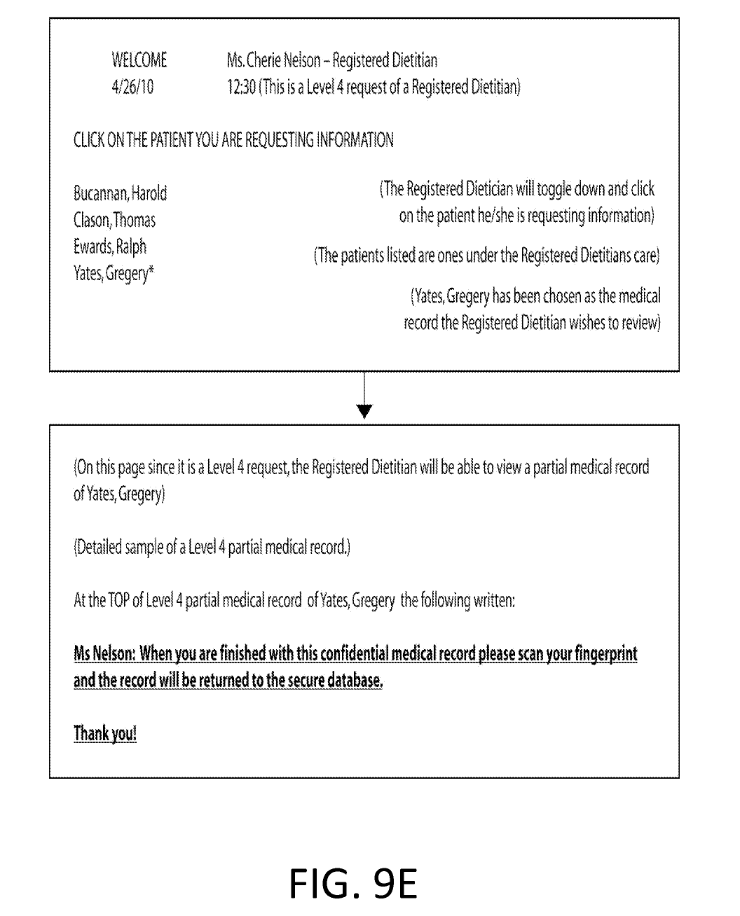

Example function flow and access implementations are provided in FIG. 8 and FIGS. 9A, 9B, 9C, 9D, and 9E. After submitting his fingerprint, Dr. William Novotney is automatically recognized as a physician and logged into the MediFingerprintID™ system of his hospital with full access to his patients that are under his care because of his ProLevel™ 5 authorization. In FIG. 9C, the doctor is reminded to return the checked out medical records back to the system. In FIG. 9E, Ms Cherie Nelson is automatically recognized as a Registered Dietitian after submitting her fingerprint, and is granted partial medical record access.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, may be found in the following publications, U.S. Pat. Nos. 5,991,730, 5,991,729, 5,946,659, 5,933,809, and 5,899,998, all of which are hereby incorporated by reference herein for all purposes.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A method for accessing a medical record database by a user, comprising the actions of:
collecting a fingerprint of the user;
submitting the fingerprint electronically to a server of the medical record database;
matching the fingerprint to a stored database of fingerprints of registered users;
automatically recognizing an access level of authority to the medical record database; and
retrieving medical records in accordance to the access level.

2. The method of claim 1, wherein the action of collecting a fingerprint is by means of a commercially available fingerprint identification system.

3. The method of claim 1, wherein the action of collecting and a fingerprint and submitting the fingerprint is by means of fingerprint IC card.

4. The method of claim 1, wherein the action of submitting fingerprint is by wireless means.

5. The method of claim 1, wherein the access level of authority is determined by “need-to-know” basis of the medical system.

6. A medical record management system, comprising:
an electronic fingerprint sensing apparatus;
a fingerprint processing device that is electronically connected with the fingerprint sensing apparatus;
a medical record database; and
a central server that is electronically connected with fingerprint processing device and the medical record database,
wherein the central server receives a fingerprint submission from a user by fingerprint processing device, and compares the fingerprint with a stored fingerprints in a fingerprint database, and automatically provides a level of access authority and retrieves a medical record in accordance to the level of access authority.

7-10. (canceled)

11. The medical record management system of claim 6 wherein the fingerprint processing device transmits fingerprint submission by wireless means.

12. The medical record management system of claim 6 wherein the fingerprint sensing apparatus is fingerprint IC card.

13. The medical record management system of claim 6 wherein the central server provides a level of access authority in accordance to “need-to-know” basis of a medical system.

14. The medical record management system of claim 6 wherein the central server receives a fingerprint submission as well as information about whether the user is a patient or a medical professional or other system user.
